(19) United States
(12) Patent Application Publication
(10) Pub. No.: US 2026/0328438 A1
(43) Pub. Date: Oct. 22, 2026

(54) SOLAR-THERMAL MODULE

(71) Applicant: HUECK SOLAR ENERGY GMBH, Munich (DE)

(72) Inventors: Ulrich Hueck, Gauting (DE); Robert Hilleke, Kodersdorf (DE)

(21) Appl. No.: 19/109,498

(22) PCT Filed: Sep. 12, 2023
(86) PCT No.: PCT/EP2023/075004

§ 371 Date: Mar. 6, 2025

(30) Foreign Application Priority Data
Sep. 14, 2022 (DE) 10 2022 209 642.8

(51) Int. Cl. F24S 20/20; F22B 1/00; F24S 40/80

(52) U.S. Cl. CPC F24S 20/20; F24S 40/80; F22B 1/006

(57) ABSTRACT

The invention relates to a solar-thermal module as part of a solar-thermal receiver with a high level of thermal efficiency for the absorption of solar radiation for heating a heat carrier medium flowing inside each solar-thermal module. The invention also relates to a solar-thermal receiver comprising the solar-thermal modules according to the invention. The invention further relates to a method for using the solar-thermal receiver.

The present invention relates to a solar-thermal module for the absorption of concentrated solar radiation for heating a heat carrier medium flowing inside the module. Furthermore, the present invention relates to a solar-thermal receiver comprising the solar-thermal modules according to the invention. Furthermore, the present invention relates to a method for using the solar-thermal receivers.

Solar-thermal energy in general is a well-known field, and solutions for efficiently generating energy from solar radiation have been discussed for many years. Nevertheless, practical problems call into question the widespread application of, for example, solar-thermal tower systems. Such solar-thermal tower systems comprise a tower, a solar-thermal receiver, which is arranged in the upper region of the tower and heats a heat carrier medium there, and a plurality of heliostats arranged on the ground, which is aligned in such a way that their mirrors reflect the solar radiation to the receiver. In the receiver, the concentrated solar radiation is converted into heat and transferred to the heat carrier medium. The heated heat carrier medium is then fed to a suitable heat consumer or heat accumulator for later use.

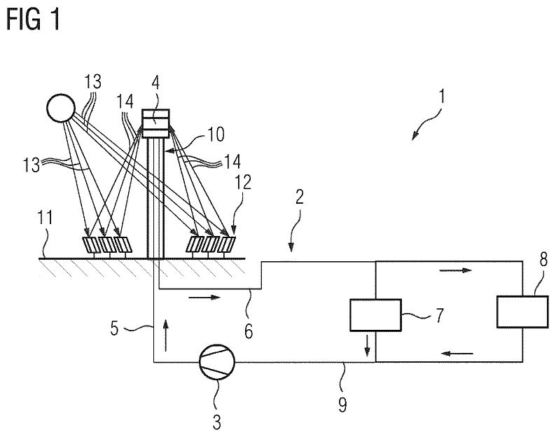

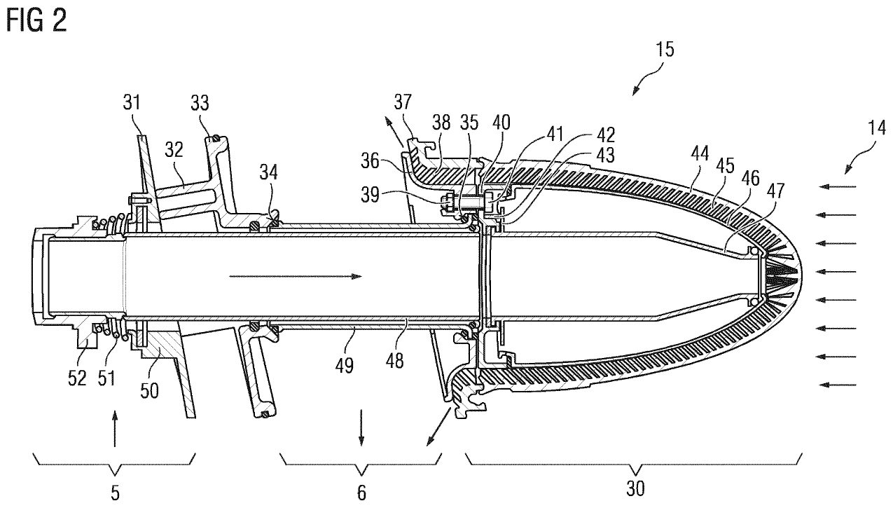

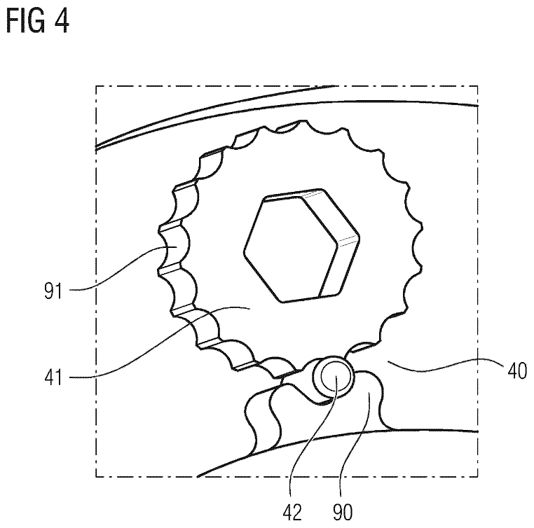

For example, patent EP 2 520 872 B1 discloses, in particular in FIG. 4 thereof, a solar-thermal module which is intended to be able to be used as a solar-thermal receiver comprising multiple solar-thermal modules similar to EP 2 520 872 B1, FIG. 2, in corresponding systems similar to EP 2 520 872 B1, FIG. 1. Due to the special shape of the outer surface with elevations and depressions, such receivers promise a higher efficiency than conventional receivers for heating a heat carrier medium with a smooth outer surface. The cold heat carrier medium is conducted directly to the elevations in the interior of such a solar-thermal module, thus cooling particularly effectively. The heat carrier medium then flows inside the module towards the recesses in the outer surface, is further heated, and finally exits the solar-thermal module. On the outer surfaces of the elevations, unabsorbed solar heat is not completely radiated into the environment-thus being lost-but rather is radiated partly onto the adjacent elevations, so that part of this heat can also be absorbed and dissipated by the heat carrier medium.

In practice, however, it turns out that such solar-thermal modules are not used because many details of the technical implementation remain unresolved. This includes, for example, the compensation of thermal expansion while maintaining mechanical stability of the modules, the appropriate sealing of the flow paths and the sufficient cooling of all thermally stressed components.

Therefore, there is still a problem in heating the heat carrier medium with a suitable solar-thermal module similar to EP 2 520 872 B1, FIG. 4, in such a way that a particularly high efficiency is achieved due to the special shape of the outer surface of a solar-thermal receiver constructed from multiple modules similar to EP 2 520 872 B1, FIG. 2. This special shape of the outer surface, which is necessary for high efficiency, includes the property that the cold heat carrier medium should cool the front tip of the solar-thermal module on its inside and then flow backwards as it heats up further. For this purpose, the incoming cold heat carrier medium must necessarily pass through the flow area of the hot outgoing heat carrier medium. In particular, there are the problems that the hot and cold zones of the solar-thermal module must be sufficiently insulated from each other, thermal expansion must be adequately compensated for, and the receiver must be sufficiently mechanically resilient and sufficiently tight. There are large temperature differences in the solar-thermal module because its outside is exposed to highly concentrated solar radiation, while the inflowing heat carrier medium has a low temperature and the outflowing medium has a high temperature.

These and other problems are solved by the devices and methods described below. Further advantageous embodiments can be found in the dependent claims and the detailed description. These advantages can be used to adapt a solution to specific needs or to solve other problems.

According to one aspect, the present invention relates to a solar-thermal module suitable for use as a component of a solar-thermal receiver for the absorption of solar radiation for heating a heat carrier medium flowing inside the solar-thermal module, having the following features, wherein the solar-thermal module has an absorption region for solar radiation,
wherein the absorption region has an outer surface, wherein the outer surface of the absorption region is substantially convex in the form of a cap,
wherein the absorption region is opaque to solar radiation,
wherein the solar-thermal module is suitable for being connected to a heat carrier medium supply channel from which the heat carrier medium enters the solar-thermal module, wherein the solar-thermal module is adapted so that the supplied heat carrier medium flows through the solar-thermal module through at least one inner tube,
wherein the heat carrier medium inside the solar-thermal module is first conveyed to the tip of the absorption region,
wherein the heat carrier medium is conducted from the tip of the absorption region inside the solar-thermal module along the remaining absorption region,
wherein the solar-thermal module is adapted for the heat carrier medium to exit through an outlet into a heat carrier medium discharge channel,
wherein the at least one inner tube comprises an inner tube A, wherein a portion of the inner tube A is adapted to pass through the heat carrier medium discharge channel,
wherein the portion of the inner tube A is enclosed by an outer tube,
wherein the outer tube is adapted to form part of the wall of the heat carrier medium discharge channel,
wherein the solar-thermal module has at least one spring element in the force flow between the inner tube A and the outer tube,
wherein the at least one spring element is adapted to compensate for the different thermal expansion of the inner tube A and the outer tube,
wherein the at least one spring element has a spring force which is transmitted in the inner tube A as a tensile force and in the outer tube A as a compressive force.

It has been observed that such a design of the solar-thermal module enables a significant minimization of thermal stresses. Furthermore, it was found that the solar-thermal modules according to the invention provide higher thermal efficiency. The solar-thermal modules according to the invention are particularly effective in absorbing focused solar radiation. Such focused solar radiation is provided, for example, by using heliostats, wherein the solar radiation from large areas can be concentrated onto the solar-thermal modules of solar-thermal receivers according to the invention.

The term “absorption region” in the context of the present invention refers to the region of the solar-thermal module which is adapted to be heated on its outside by solar radiation and cooled on its inside by the heat carrier medium.

The term “tip of the absorption region” in the context of the present invention refers to the end of the solar-thermal module which is opposite the inflow end of the solar-thermal module, which is adapted so that the heat carrier medium flows into the solar-thermal module through the inflow end.

The term “substantially convex outer surface of the absorption region” in the context of the present invention means that the outer surface of the absorption region of the solar-thermal module has a substantially convex shape. Preferably, only the connecting regions of the absorption regions arranged next to one another have non-convex components.

According to a further aspect, the present invention relates to a solar-thermal receiver comprising a plurality of solar-thermal modules according to the invention, a heat carrier medium supply channel, and a heat carrier medium discharge channel,
wherein the heat carrier medium supply channel is connected to the plurality of solar-thermal modules,
wherein a part of the heat carrier medium discharge channel is formed by an outer tube of the plurality of solar-thermal modules.

According to a further aspect, the present invention relates to a method for obtaining thermal energy from solar radiation, wherein solar radiation is absorbed by means of a plurality of solar-thermal modules according to the invention and the heat thereof is transferred into a heat carrier medium,
wherein the heat carrier medium from the plurality of solar-thermal modules is conveyed into a heat carrier medium discharge channel,
wherein the heat carrier medium is conducted from the heat carrier medium discharge channel into at least one heat consumer and/or into at least one heat accumulator,
wherein the heat carrier medium is conducted from the at least one heat consumer and/or the at least one heat accumulator into the heat carrier medium supply channel,
wherein the heat carrier medium is conducted from the heat carrier medium supply channel once again into the plurality of solar-thermal modules.

To facilitate the understanding of the invention, reference is made to the following detailed description and the attached figures. It should be understood that the following details of the embodiments should not be construed as limitations on the present invention. Instead, they represent preferred embodiments with particular advantages which may serve to better understand the present invention.

FIG. 1 shows a schematic view of a solar-thermal tower system.

FIG. 2 shows a sectional view through a single solar-thermal module according to an embodiment of the present invention.

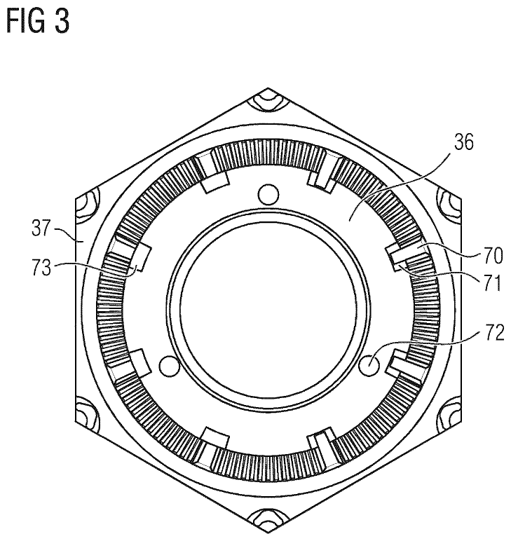

FIG. 3 shows a partial view of the vertical support structure of the solar-thermal module with webs and recesses according to advantageous embodiments of the present invention, as is also integrated, for example, into the solar-thermal module according to the invention shown in FIG. 2.

FIG. 4 shows a partial view of the anti-rotation device of a screw head according to advantageous embodiments of the present invention, as is also integrated, for example, into the solar-thermal module shown in FIG. 2.

According to one aspect, the present invention relates to a solar-thermal module as described above.

According to further embodiments, it is preferred that the solar-thermal module comprises a base plate B and a guide B, wherein the base plate B and the guide B are suitable for forming lateral boundaries of the heat carrier medium discharge channel, wherein the guide B is connected to a base plate C, wherein the solar-thermal module has an articulated connection on a contact surface between the base plate B and an outer tube and on a contact surface between the guide B and the outer tube. It has been found that with such embodiments of the solar-thermal module according to the invention, a vertical height offset in the heat carrier medium discharge channel between its rear wall as base plate B and its front wall as base plate C and the associated guide B in the region of the outer tube leading through it can be compensated for very effectively. The term “articulated connection” in the context of the present invention is to be understood as a movable connection between at least two rigid bodies.

According to further embodiments, it is preferred that the solar-thermal module has a vertical and horizontal inner support structure on the side illuminated by the solar radiation, wherein the inner support structure consists of a base plate C and a guide B and a flange screwed to it, wherein the base plate C is mechanically decoupled from the guide B and the flange by virtue of the fact that multiple webs of the base plate C distributed over the circumference are guided into indentations of the guide B. It was found that for typical applications, noticeable mechanical stresses can build up in the solar-thermal module. However, due to the structure described above, it is possible that only small mechanical stresses build up in the solar-thermal module even in the face of very large temperature differences between the inner region of the support structure of the solar-thermal module, which is not illuminated by solar radiation, and the outer region of the support structure of the solar-thermal module, which is illuminated by solar radiation.

According to further embodiments, it is preferred that the connection between the heat carrier medium supply channel and the inside of the tip of the absorption region consists of at least two conduits, wherein the at least two conduits are connected to one another in an articulated manner. For example, in embodiments in which the attachment of the inner tube B to the inside of the tip of the absorption region is rather delicate, it has been observed that this structure achieves improved mechanical reliability of the solar-thermal module.

According to further embodiments, it is preferred that a base plate A, an inner tube A and an inner tube B, and preferably all components which are adapted to conduct the heat carrier medium in the interior of the solar-thermal module to the tip of the absorption region, consist of metallic materials, and a cap with cooling elements, a guide A, a flange, a base plate C with cooling elements, a guide B, an outer tube and a base plate B, and preferably all components which are adapted to conduct the heat carrier medium in the interior of the solar-thermal module away from the tip of the absorption region, consist of ceramic materials. Such a structure has proven to be advantageous in order to minimize the mechanical stresses occurring as a result of the specific structure. The aforementioned material combination makes it very easy to keep thermal stresses low during operation of the solar-thermal module.

Furthermore, it has proven advantageous for typical applications if the inner tube B consists of at least one ceramic material. According to further embodiments, it is preferred that a base plate A and an inner tube A, and preferably all components which are adapted to conduct the heat carrier medium in the interior of the solar-thermal module up to the tip of the absorption region, consist of metallic materials, wherein an inner tube B, a cap with cooling elements, a guide A, a flange, a base plate C with cooling elements, a guide B, an outer tube and a base plate B, and preferably all components which are adapted to conduct the heat carrier medium in the interior of the solar-thermal module up to the tip of the absorption region and then away from the tip of the absorption region, consist of ceramic materials. Such a structure has proven to be advantageous in order to minimize the mechanical stresses occurring as a result of the specific structure and at the same time to provide increased resistance to thermal stresses at this specific location. This provides a particularly advantageous design for applications subject to high thermal and mechanical stress.

According to further embodiments, it is preferred that a plurality of cooling elements is located on a base plate C, the cooling elements each adjoining a guide B with a small spacing, the base plate C and the guide B forming a flow channel for the heat carrier medium, the solar-thermal module having a flow channel for the heat carrier medium, the surfaces of the base plate C and the guide B being geometrically shaped such that the remaining free cross-sectional area of the flow channel continuously decreases in the direction of flow. The term “small spacing” as mentioned above means that the tips of the cooling elements come close to the surface of the guide B facing them, preferably as close as possible, but still maintain a sufficiently large spacing so that they do not hit the guide B at the maximum possible thermal expansion-without causing unacceptably high pressure forces on the cooling elements. The maximum possible thermal expansion results from the maximum possible temperature differences of the base plate C, the cooling elements and the guide B.

According to further embodiments, it is preferred that in the interior of the solar-thermal module there are screw connections distributed over the circumference, each of which comprises a screw and a nut, wherein the screw has a head, wherein the head of the screw is provided with at least one indentation in the longitudinal direction, preferably with indentations all around, wherein next to the head of the screw there is a retaining recess, for example on the flange, and wherein the at least one indentation and the retaining recess are suitable for receiving a securing pin. It has been observed that a further improvement in the structure of the solar-thermal module according to the invention can be achieved by such a securing option. Typically, it is preferred that the solar-thermal module also comprises the securing pin on the screw arranged inside. In such embodiments, the screw connections also comprise a safety pin. Such a securing pin provides a simple and reliable way to prevent the screw from turning accidentally.

According to further embodiments, it is preferred that the solar-thermal module has a base plate C, wherein the base plate C has at least one attachment for adjacent solar-thermal modules, wherein the at least one attachment is adapted such that the heat carrier medium is conducted along under the at least one attachment before the heat carrier medium leaves the solar-thermal module. Although the heat carrier medium already has a very high temperature when used at this point, it has been found that the cooling effect achievable is very advantageous in typical applications. Particularly in the case of very strongly focused, intense solar radiation, the attachments of the neighboring solar-thermal modules can heat up very strongly, so that the cooling mentioned above further increases the range application without any significant additional effort.

According to further embodiments, it is preferred that the solar-thermal module comprises a flange, an inner tube B, a guide A and a cap, wherein the inner tube B, the guide A and the cap are each attached to the flange by means of bayonet locks. In order to attach the inner tube B, the guide A and the cap to the flange by means of a bayonet lock, it is necessary to use a relatively complex structure of the solar-thermal module. However, it has been shown that in addition to the reliable attachment of the components, a particularly space-saving construction is also possible in this way.

According to a further aspect, the present invention relates to a solar-thermal receiver as described above.

According to a further aspect, the present invention relates to a method as described above.

According to further embodiments, it is preferred that the heat carrier medium is conveyed into at least one heat consumer, wherein the at least one heat consumer comprises at least one heat exchanger. Preferably, the at least one heat exchanger is a steam boiler and/or a preheater of a steam boiler. For example, such steam boilers and preheaters can be used in steam turbines. It has been found that renewable energy can be used very efficiently for industrial applications, especially steam turbines.

FIG. 1 shows a schematic view of a solar-thermal tower system 1. The solar-thermal tower system 1 comprises a heat carrier medium circuit 2 through which a gaseous heat carrier medium, for example air, is conducted. Integrated into the heat carrier medium circuit 2 are a compressor 3 which compresses the heat carrier medium, a solar-thermal receiver 4 according to an embodiment of the present invention, which is supplied with the heat carrier medium compressed by the compressor 3 via a heat carrier medium supply channel 5, for example in the form of a conduit, a heat carrier medium discharge channel 6, for example in the form of a conduit, a heat consumer 8, for example in the form of a heat-recovery steam generator, and optionally a heat accumulator 7, which can be designed as a solid heat accumulator. From the heat consumer 8 and the heat accumulator 7, the heat carrier medium can then be conveyed back to the compressor 3 via a further connecting line 9, provided that the heat carrier medium circuit 2 is closed at this point.

The solar-thermal tower system 1 further comprises a tower 10, in the upper region of which the solar-thermal receiver 4 is arranged, and a plurality of heliostats 12 arranged on the ground 11, which is positioned in the manner of a ring or ring segment around the tower 10. The heliostats 12 are arranged and aligned such that they reflect the solar radiation 13 and thus concentrate it as concentrated solar radiation 14 on the solar-thermal receiver 4. For this purpose, the heliostats 12 are motor-driven in at least two axes to track the sun.

During operation of the solar-thermal tower system 1, the gaseous heat carrier medium is compressed using the compressor 3 and fed to the solar-thermal receiver 4 via the heat carrier medium supply channel 5. The heliostats 12 bundle and concentrate the solar radiation 14 onto the solar-thermal receiver 4, through which the heat carrier medium flows. The heat carrier medium is heated to temperatures in the range of several hundred degrees Celsius. The heated heat carrier medium is then guided via the heat carrier medium discharge channel 6 in the direction of the heat consumer 8 or in the direction of the heat accumulator 7, where the heat carrier medium releases its heat and is cooled accordingly. The cooled heat carrier medium can then be conducted back to the solar-thermal receiver 4 via the connecting line 9 and the heat carrier medium supply channel 5, provided that the circuit between the heat consumer 8, the heat accumulator 7 and the compressor 3 is closed.

FIG. 2 shows a portion of the solar-thermal receiver 4 shown in FIG. 1, comprising a solar-thermal module 15 according to the invention. A solar-thermal receiver 4 comprises a large number of almost identical solar-thermal modules 15 connected in parallel. Here, the base plate A 31, the base plate B 33 and the base plate C 37 are each aligned vertically so that the absorption region 30 faces the solar radiation 14 reflected from the ground at a suitable angle. Viewed from the direction of the solar radiation 14, the absorption region 30 of the solar-thermal module 15 is convex in its center and concave at its edges.

A solar-thermal module 15 comprises a channel-shaped continuation of the heat carrier medium supply channel 5 and the heat carrier medium discharge channel 6 in the interior of the solar-thermal receiver 4 formed from many modules 15. The base plate A 31 forms the outer side of the continuation of the heat carrier medium supply channel 5. The inner side of this heat carrier medium supply channel 5 is omitted in the solar-thermal receiver 4 if it is designed to be completely cylindrical. Also, it is not shown in FIG. 2 for a design which is not completely cylindrical, since it is irrelevant for the representation of the invention. The base plate B 33 and the base plate C 37 form the side walls of the heat carrier medium discharge channel 6 inside the solar-thermal receiver 4, which becomes an annular channel in the case of a completely cylindrical design and forms a ring segment in the case of a not completely cylindrical design.

The cold heat carrier medium enters the inner tube A 48 of each individual solar-thermal module 15 from the heat carrier medium supply channel 5, then flows through the inner tube B 47 and is thus conducted to the inside of the tip of the absorption region 30. The outside of the absorption region 30 consists of the cap 44 and the base plate C 37, both of which are strongly heated by the concentrated solar radiation 14 and transfer the heat absorbed to the heat carrier medium flowing along their inner sides. For this purpose, the cap 44 has on its inner side a plurality of cooling elements 45 which are adjacent to the guide A 46 and to the outside of the flange 40 with a small spacing, while the base plate C 37 has on its inner side a plurality of cooling elements 38 which is adjacent to the guide B 36 with a small spacing, which in their entirety form the flow channel of an individual module 15 for heating the heat carrier medium. The heated heat carrier medium exits through a circumferential gap between the base plate C 37 and guide B 36, whereupon it enters the common heat carrier medium discharge channel 6 of all solar-thermal modules 15 connected in parallel.

For the mechanical attachment, the inner tube A 48 is connected on its inlet side to a retaining nut 52, which biases a spring element 51. The compressive force of the spring element 51 is transmitted to the base plate A 31 via the sleeve 50. At the same time, the spring element 51 exerts a tensile force on the inner tube A 48 via the retaining nut 52. At the outlet side of the inner tube A 48, a collar thereon directs a corresponding pressure force into the outer tube 49. This pressure force is directed from the outer tube 49 with a collar located thereon via an articulated contact surface 34 into the base plate B 33, which is supported on the base plate A 31 via spacers 32. This continues the force flow generated by the biased spring element 51. This makes different thermal expansions of the inner tube A 48 and the outer tube 49 possible without the mechanical cohesion of these two and the other components mentioned being lost.

The outer tube 49, which is held by the spring force of the spring element 51, also has a collar on its side facing the absorption region 30, which can move in an articulated manner in the contact surface 35 of the guide B 36. The articulated connection of the outer tube 49 with the base plate C 37 and with the other components in the absorption region 30 is achieved by the aforementioned collar of the outer tube 49 being surrounded by the guide B 36 and the flange 40. The guide B 36 and the flange 40 are pulled together with multiple screw connections distributed over the circumference, each consisting of a screw 41 and a nut 39, in such a way that they enclose the aforementioned collar of the outer tube 49. The articulated contact surfaces 34 and 35 enable a vertical height offset of the two side walls of the heat carrier medium discharge channel 6.

The head of the screw 41 is secured against rotation by means of the securing pin 42. A cover 43 located on the inner tube B 47 holds this securing pin 42 in position and thus prevents it from accidentally falling out. The nut 39 is also positively secured against rotation in its retaining recess of the guide B 36.

The inner tube B 47, the guide A 46 and the cap 44 are each attached to the flange 40 by means of bayonet locks.

During operation, the heat carrier medium is conducted from the relatively cold heat carrier medium supply channel 5 through the inner tube A 48 and thus through the hot heat carrier medium discharge channel 6 in order to cool the absorption region 30 after flowing through the inner tube B 47. This cooling effect would be significantly reduced if the heat carrier medium were to heat up considerably as it flows through the inner tube A 48 through the heat carrier medium discharge channel 6. Therefore, this passage is formed in a double-shell form with the inner tube A 48 and the outer tube 49, which improves the efficiency of the solar-thermal module 15.

It was found that for the inventive construction of the solar-thermal modules 15 it is typically advantageous to take into account the thermal expansion of the materials. During operation, different temperatures arise in the components through which the cold heat carrier medium flows compared to the components around which the hot heat carrier medium flows. While metallic materials exhibit high thermal expansion, the thermal expansion of ceramic materials is low. Therefore, if metallic materials are subjected to a small temperature change and ceramic materials to a large temperature change, similar absolute thermal expansions result for the metallic and ceramic components, which enables a design with overall lower thermal stresses. Against this background, in particular the base plate A 31, the inner tube A 48 and the inner tube B 47 are made of metallic materials. Alternatively, the inner tube B 47 was made of at least one ceramic material, which is typically advantageous for many applications due to its higher thermal load capacity. Additionally made of ceramic materials are in particular the cap 44 with the cooling elements 45, the guide A 46, the flange 40, the base plate C 37 with the cooling elements 38, the guide B 36, the outer tube 49 and the base plate B 33.

Nevertheless, during operation of the solar-thermal module, 15 different thermal expansions of the various components remain. The greatest changes in length can occur between the cold inner tube A 48 and the hot outer tube 49. The spring element 51 compensates for such different changes in length without the cohesion of the solar-thermal module 15 being lost.

If multiple solar-thermal modules 15 are stacked on top of each other, different vertical displacements of the hot base plate B 33 and the significantly hotter base plate C 37, which is heated directly by the solar radiation 14, can also occur. Due to the articulated contact surfaces 34 and 35, a vertical offset of the two base plates 33 and 37 is possible during operation of the system without causing unacceptably high thermal stresses in the connecting outer tube 49.

Although a vertical offset of the two base plates 33 and 37 is permitted, this must not result in a leverage force which could have a destructive effect on the delicate transition from the inner tube B 47 to the guide A 46. Therefore, the supply of the cold heat carrier medium from the heat carrier medium supply channel 5 to the inlet into the interior of the cap 44 is substantially carried out with two separate components, namely the inner tube A 48 and the inner tube B 47. The connection between these two inner tubes is made movable by the connections to the outer tube 49 and to the flange 40, because the outer tube 49 is movably mounted between the guide B 36 and flange 40.

FIG. 3 shows a partial view of the vertical support structure of the solar-thermal module 15 with webs and recesses according to advantageous embodiments of the present invention, as is also integrated, for example, in the solar-thermal module according to the invention shown in FIG. 2. On the inside of the base plate C 37 there are multiple webs 70 distributed over the circumference, which project into indentations 71 of the guide B 36 and are each supported there by means of a seal 73. For illustration purposes, FIG. 3 shows four webs 70 without the seals 73 on the right and four webs 70 with the seals 73 on the left. The bores 72 serve as a passage for the screw connection shown in FIG. 2, each consisting of a screw 41 and nut 39, with the help of which the webs 70 are enclosed by the guide B 36 and the flange 40 and thus held in position.

During operation of the solar-thermal module 15, the external base plate C 37 has a significantly higher temperature than the internal guide B 36 and the flange 40. Due to the mechanical decoupling shown in FIG. 3, the base plate C 37 can expand more freely than the guide B 36 and the flange 40 without the required mechanical connection between these three components being lost in the axial direction.

By separating the vertical and horizontal support structure on the side of the solar-thermal module 15 facing the solar radiation 14 into the base plate C 37 and the components guide B 36 and flange 40 which are screwed together, greatly differing temperatures do not lead to unacceptably high thermal stresses in the radial direction, while the support function in the axial direction remains present.

FIG. 4 shows a partial view of the anti-rotation device of a screw head according to advantageous embodiments of the present invention, as is also integrated, for example, in the solar-thermal module shown in FIG. 2. The head of the screw 41 is provided with indentations 91 running along its length. Next to the head of the screw 41 there is a retaining recess 90 on the flange 40. The positive locking against rotation of the screw 41 is achieved by inserting a securing pin 42 into the retaining recess 90 and at the same time into an indentation 91 on the head of the screw 41.

Although the invention has been illustrated and described in detail by the preferred embodiment, the invention is not limited to the disclosed examples and other variations can be derived therefrom by those skilled in the art without departing from the scope of the invention.

1. A solar-thermal module (15) suitable for use as a component of a solar-thermal receiver (4) for the absorption of solar radiation (14) for heating a heat carrier medium flowing inside the solar-thermal module (15), having the following features:
wherein the solar-thermal module (15) has an absorption region (30) for solar radiation (14), wherein the absorption region (30) has an outer surface,
wherein the outer surface of the absorption region (30) is substantially convex in the form of a cap wherein the absorption region (30) is opaque to solar radiation (14),
wherein the solar-thermal module (15) is suitable for being connected to a heat carrier medium supply channel (5) from which the heat carrier medium enters the solar-thermal module (15),
wherein the solar-thermal module (15) is adapted so that the supplied heat carrier medium flows through the solar-thermal module (15) through at least one inner tube (47, 48),
wherein the heat carrier medium inside the solar-thermal module (15) is first conveyed to the tip of the absorption region (30),
wherein the heat carrier medium is conducted from the tip of the absorption region (30) inside the solar-thermal module along the remaining absorption region (30), wherein the solar-thermal module (15) is adapted for the heat carrier medium to exit through an outlet into a heat carrier medium discharge channel (6),
wherein the at least one inner tube (47, 48) comprises an inner tube A (48),
characterized in that
a portion of the inner tube A (48) is adapted to pass through the heat carrier medium discharge channel (6),
wherein the portion of the inner tube A (48) is enclosed by an outer tube (49),
wherein the outer tube (49) is adapted to form part of the wall of the heat carrier medium discharge channel (6), wherein the solar-thermal module (15) has at least one spring element (51) in the force flow between the inner tube A (48) and the outer tube (49),
wherein the at least one spring element (51) is adapted to compensate for the different thermal expansion of the inner tube A (48) and the outer tube (49),
wherein the at least one spring element (51) has a spring force which is transmitted in the inner tube A (48) as a tensile force and in the outer tube (49) as a compressive force.

2. The solar-thermal module (15) according to claim 1, having the following features,
wherein the solar-thermal module comprises a base plate B (33) and a guide B (36),
wherein the base plate B (33) and the guide B (36) are suitable for forming lateral boundaries of the heat carrier medium discharge channel (6),
wherein the guide B (36) is connected to a base plate C (37),
characterized in that
the solar-thermal module (15) has an articulated connection on a contact surface (34) between the base plate B (33) and an outer tube (49) and on a contact surface (35) between the guide B (36) and outer tube (49).

3. The solar-thermal module (15) according to claim 1, having the following features,
wherein the solar-thermal module (15) has a vertical and horizontal inner support structure on the side illuminated by the solar radiation (14),
characterized in that
the inner support structure consists of a base plate C (37), and also a guide B (36) and a flange (40) screwed thereto,
wherein the base plate C (37) is mechanically decoupled from the guide B (36) and the flange (40) by virtue of the fact that multiple webs (70) of the base plate C (37) distributed over the circumference are guided into indentations (71) of the guide B (36).

4. The solar-thermal module (15) according to claim 1,
characterized in that
the connection between the heat carrier medium supply channel (5) and the inside of the tip of the absorption region (30) consists of at least two conduits (48, 47),
wherein the at least two conduits are connected to one another in an articulated manner.

5. The solar-thermal module (15) according to claim 1,
characterized in that
a base plate A (31) and an inner tube A (48), and preferably all components which are adapted to conduct the heat carrier medium inside the solar-thermal module (15) up to the vicinity of the tip of the absorption region (30), consist of metallic materials, and
wherein an inner tube B (47), a cap (44) with cooling elements (45), a guide A (46), a flange (40), a base plate C (37) with cooling elements (38), a guide B (36), an outer tube (49) and a base plate B (33), and preferably all components which are adapted to conduct the heat carrier medium in the interior of the solar-thermal module (15) to the tip of the absorption region (3) and away from the tip of the absorption region (30), consist of ceramic materials.

6. The solar-thermal module (15) according to claim 1, having the following features,
wherein a plurality of cooling elements (38) is located on a base plate C (37),
characterized in that
the cooling elements (38) are each adjacent to a guide B (36) with a small spacing,
wherein the base plate C (37) and the guide B (36) form a flow channel for the heat carrier medium,
wherein the solar-thermal module (15) has a flow channel for the heat carrier medium,
wherein the surfaces of the base plate C (37) and the guide B (36) are geometrically designed such that the remaining cross-sectional area of the flow channel continuously decreases in the flow direction.

7. The solar-thermal module (15) according to claim 1, having the following features,
wherein in the interior of the solar-thermal module (15) there are screw connections distributed over the circumference, each comprising a screw (41) and a nut (39),
characterized in that
the screw has a head,
wherein the head of the screw (41) is provided with at least one indentation (91), preferably with multiple indentations (91), which run in the longitudinal direction around the circumference, wherein a retaining recess (90) is provided next to the head of the screw (41), for example on the flange (40), and
wherein the at least one indentation (91) and the retaining recess (90) are suitable for receiving a securing pin (42).

8. The solar-thermal module (15) according to claim 1, having the following features,
characterized in that
the solar-thermal module (15) comprises a flange (40), an inner tube B (47), a guide A (46) and a cap (44), wherein the inner tube B (47), the guide A (46) and the cap (44) are each fastened to the flange (40) by means of bayonet closures.

9. The solar-thermal receiver (4) comprising a plurality of solar-thermal modules (15) according to claim 1, a heat carrier medium supply channel (5) and a heat carrier medium discharge channel (6),
wherein the heat carrier medium supply channel (5) is connected to the plurality of solar-thermal modules (15),
wherein a part of the heat carrier medium discharge channel (6) is formed by an outer tube (49) of the plurality of solar-thermal modules (15).

10. A method for obtaining thermal energy from solar radiation, wherein solar radiation is absorbed by means of a plurality of solar-thermal modules (15) according to claim 1 and is transferred into a heat carrier medium, wherein the heat carrier medium is conveyed from the plurality of solar-thermal modules (15) into a heat carrier medium discharge channel (6),
wherein the heat carrier medium is conducted from the heat carrier medium discharge channel (6) into at least one heat consumer (8) and/or into at least one heat accumulator (7), wherein the heat carrier medium is conducted from the at least one heat consumer (8) and/or the at least one heat accumulator (7) into the heat carrier medium supply channel (5), wherein the heat carrier medium is conducted from the heat carrier medium supply channel (5) once again into the plurality of solar-thermal modules (15).

11. The method according to claim 10, wherein the heat carrier medium is conducted into at least one heat consumer (8), wherein the heat consumer (8) comprises at least one heat exchanger, wherein the heat exchanger is a heat exchanger of a steam boiler and/or a preheater of a steam boiler.
